(19) United States
(12) Patent Application Publication
(10) Pub. No.: US 2014/0291492 A1
(43) Pub. Date: Oct. 2, 2014

(54) IRRADIANCE MEASURING INSTRUMENT FOR MICROSCOPE, AND MICROSCOPE HAVING THE IRRADIANCE MEASURING INSTRUMENT

(71) Applicant: OLYMPUS CORPORATION, Tokyo (JP)

(72) Inventor: Kenichi KUSAKA, Brookline, MA (US)

(21) Appl. No.: 14/189,446

(22) Filed: Feb. 25, 2014

(30) Foreign Application Priority Data
Mar. 27, 2013 (JP) 2013-066556
Jan. 9, 2014 (JP) 2014-002775

(51) Int. Cl. G01J 1/42; G01N 21/64

(52) U.S. Cl. CPC G01J 1/42; G01N 21/64
USPC 250/216

(57) ABSTRACT

An irradiance measuring instrument for a microscope is intended to measure irradiance of light emitted from an objective of the microscope. The irradiance measuring instrument for a microscope includes, in an order where the light emitted from the objective proceeds, an optical system including a single lens that has a nearly flat surface oriented toward the side of the objective and also has positive power, and a photodetector configured to detect the light in order to measure the irradiance of the light on the nearly flat surface.

### CROSS REFERENCE TO RELATED APPLICATIONS

This application is based upon and claims the benefit of priority from prior Japanese Patent Applications Nos. 2013-066556, filed on Mar. 27, 2013 and 2014-002775, filed on Jan. 9, 2014, the entire contents of which are incorporated herein by this reference.

### BACKGROUND OF THE INVENTION

1. Field of the Invention

The present invention relates to an irradiance measuring instrument for a microscope, and a microscope having the irradiance measuring instrument.

2. Description of the Related Art

Fluorescence microscopes are widely used in a biological research field at present also due to a variety of observation targets widened by putting fluorescent proteins such as GFP (Green Fluorescent Protein), YFP (Yellow Fluorescent Protein), and the like into practical use.

Incidentally, conditions of an experiment are normally disclosed along with results of the experiment so that other researchers can reproduce the experiment when the results of the experiment are announced with a paper or the like. However, irradiance of excitation light in an experiment conducted with a fluorescence microscope is rarely disclosed although it is one of important conditions of an experiment in a fluorescent observation.

This is probably due to the reason that means for measuring irradiance are not sufficiently provided to researchers at the present moment, and irradiance is not always measured for this reason.

A technique for measuring an intensity of excitation light is disclosed, for example, by Japanese Laid-open Patent Publications Nos. 2005-352146 and 2012-113188. Japanese Laid-open Patent Publication No. 2005-352146 discloses a microscope illumination intensity measuring device, which includes a light-receiving unit fixed to a stage of a microscope. Moreover, Japanese Laid-open Patent Publication No. 2012-113188 discloses a light intensity measuring unit attached to a revolving nosepiece as a replacement for an objective.

### SUMMARY OF THE INVENTION

An aspect of the present invention provides an irradiance measuring instrument for a microscope, which is intended to measure irradiance of light emitted from an objective of the microscope, includes, in an order where the light emitted from the objective proceeds, an optical system including a single lens that has a nearly flat surface oriented toward the side of the objective and also has positive power, and a photodetector configured to detect the light in order to measure the irradiance of the light on the nearly flat surface.

Another aspect of the present invention provides a microscope having the irradiance measuring instrument for a microscope in the above described aspect.

### BRIEF DESCRIPTION OF THE DRAWINGS

The present invention will be more apparent from the following detailed description when the accompanying drawings are referenced.

FIG. 1A schematically illustrates a configuration of a device for measuring irradiance according to an embodiment of the present invention;

FIG. 1B is a top view of an irradiance measuring instrument included in the device illustrated in FIG. 1A when viewed from the side of an objective;

FIG. 2 is a cross-sectional view of an optical system included in an irradiance measuring instrument for a microscope according to a first embodiment of the present invention;

FIG. 3 is a cross-sectional view of an optical system included in an irradiance measuring instrument for a microscope according to a second embodiment of the present invention;

FIG. 4 is a cross-sectional view of an optical system included in an irradiance measuring instrument for a microscope according to a third embodiment of the present invention; and

FIG. 5 is a cross-sectional view of an optical system included in an irradiance measuring instrument for a microscope according to a fourth embodiment of the present invention.

### DESCRIPTION OF THE EMBODIMENTS

To reproduce an experiment with a fluorescence microscope, not the total quantity of light irradiated on a sample surface but the quantity of light per unit area irradiated on the sample surface is important. However, the microscope illumination intensity measuring device disclosed by Japanese Laid-open Patent Publication No. 2005-352146 is not a device for measuring irradiance, which is a radiant flux per unit area. Accordingly, it is difficult to accurately measure irradiance. Moreover, the light intensity measuring unit disclosed by Japanese Laid-open Patent Publication No. 2012-113188 does not recognize, as a measurement target, light that passes though an objective. Accordingly, to accurately calculate irradiance on a sample surface based on measurement results, transmittance data of an objective, which is used in an observation, is further needed in addition to transmittance data of the light intensity measuring unit. Considering that it is not always easy to obtain the transmittance data of the objective, such a demand can possibly be a factor that restricts the use of the light intensity measuring unit.

Additionally, the device disclosed by Japanese Laid-open Patent Publication No. 2005-352146 and the device disclosed by Japanese Laid-open Patent Publication No. 2012-113188 do not take into account an incidence angle characteristic of a power meter (the light-receiving unit of Japanese Laid-open Patent Publication No. 2005-352146, and the photodetector of Japanese Laid-open Patent Publication No. 2012-113188). The power meter normally exhibits low detection efficiency for light incident at a large incidence angle in comparison with detection efficiency for vertically incident light. Accordingly, it is difficult for the device disclosed by Japanese Laid-open Patent Publication No. 2005-352146 and that disclosed by Japanese Laid-open Patent Publication No. 2012-113188 to accurately measure irradiance in an observation using an objective that is frequently used in a fluorescence microscope and has a large numerical aperture (hereinafter abbreviated to NA). Moreover, for the device disclosed by Japanese Laid-open Patent Publication No. 2005-352146, its light-receiving surface cannot be used by being immersed in an immersion liquid such as oil or the like. Therefore, this device cannot support an environment where a liquid immersion objective is used.

A device, common to embodiments, used to measure irradiance is described prior to descriptions of the embodiments according to the present invention.

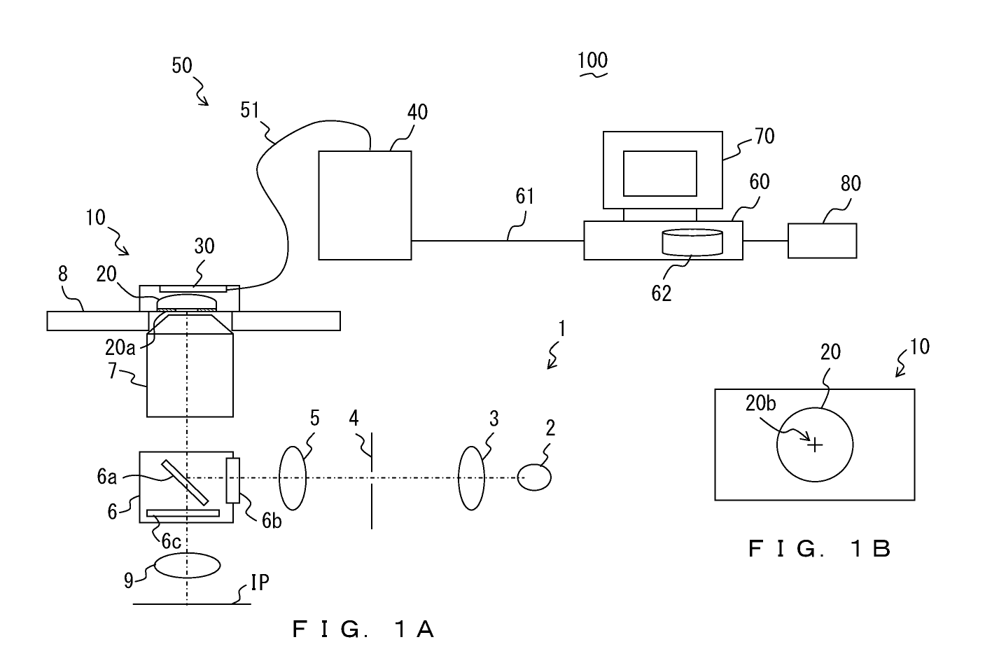

FIGS. 1A and 1B schematically illustrate a configuration of a device used to measure irradiance according to an embodiment of the present invention. The device 100 illustrated in FIG. 1A is a device for measuring irradiance of light irradiated on a sample surface by a microscope 1. The device 100 includes the microscope 1, an irradiance measuring instrument 10 arranged on a stage 8 of the microscope 1, a power meter main body 40, a computer 60, a monitor 70, and an input device 80. A sensor unit 30 included in the irradiance measuring instrument 10 is connected to a power meter main body 40 by a cable 51. The sensor unit 30 and the power meter main body 40 configure a power meter 50.

The microscope 1 is an inverted microscope having an objective 7, which is inserted from below into an opening provided in the stage 8 and is arranged so that a tip of the objective is positioned in the vicinity of an upper surface of the stage 8. The microscope 1 is configured as a fluorescence microscope. The fluorescence microscope used in a fluorescent observation that needs irradiance as an especially important experimental condition is referred to here. However, the device 100 including the irradiance measuring instrument 10 can measure irradiance of light irradiated on a sample surface by an arbitrary microscope, which is not particularly limited to a fluorescence microscope. Moreover, also with an upright microscope as a replacement for an inverted microscope, irradiance can be similarly measured.

As illustrated in FIG. 1A, the microscope 1 includes a light source 2, a collector lens 3, a field stop 4 arranged at a position optically conjugate with the upper surface (namely, a sample surface when a sample is placed on the stage 8) of the stage 8, an illumination lens 5, a fluorescence filter block 6, the objective 7, the stage 8 on which the irradiance measuring instrument 10 is arranged, a tube lens 9 for forming a primary image of a sample on a primary image plane IP, and observation means not illustrated. Moreover, the irradiance measuring instrument 10 arranged on the stage 8 may be regarded as one component of the microscope 1.

Note that a transmission illumination device, not illustrated, may be arranged above the irradiance measuring instrument 10.

The fluorescence filter block 6 is configured with a dichroic mirror 6a which reflects light emitted from the light source 2 and allows passage of fluorescence, an excitation filter 6b which allows passage of light having a wavelength suitable for exciting a fluorescent substance within the light emitted from the light source 2, and a barrier filter 6c which blocks the light emitted from the light source 2.

The objective 7 is attached to a revolving nosepiece not illustrated. The objective 7 is used by being switched among objectives of different specifications when needed. If the objective 7 is a liquid immersion objective, irradiance is measured in a state where an immersion liquid such as oil or the like is filled between the objective 7 and the irradiance measuring instrument 10.

When irradiance is measured, the irradiance measuring instrument 10 is arranged on the stage 8 as illustrated in FIG. 1A. However, when a sample is observed with the microscope, the sample is placed on the stage 8. The sample is placed on the stage 8 in a state of being held by a sample holding member such as a petri dish, a slide glass, or the like.

The irradiance measuring instrument 10 is an irradiance measuring instrument for a microscope, which is used by being arranged on the stage 8, and intended to measure irradiance of light emitted from the objective 7 of the microscope 1. The irradiance measuring instrument 10 includes a lens unit 20 and a sensor unit 30 sequentially from the side of the stage 8 (namely, in an order where the light emitted from the objective 7 proceeds) as illustrated in FIG. 1A when the irradiance measuring instrument 10 is arranged on the stage 8.

The irradiance measuring instrument 10 including the lens unit 20 and the sensor unit 30 further includes an indicator part, adhered to the side of a nearly flat surface of a single lens included in the lens unit 20, for arranging the irradiance measuring instrument 10 at a specified position with respect to an optical axis of the objective 7. This indicator part is a metal thin plate 20a that is provided on the nearly flat surface of the single lens included in the lens unit 20 and has a circular hole. By adjusting the focus to a frame of the metal thin plate 20a, the optical axis direction of the objective 7 can be adjusted with respect to the irradiance measuring instrument 10. Moreover, by moving the stage 8 from the adjusted position in a horizontal direction, the position of the irradiance measuring instrument 10 can be adjusted in a direction perpendicular to the optical axis. Additionally, as illustrated in FIG. 1B, the indicator part may be a cross line 20b, a scale mark, or the like provided on the nearly flat surface of the single lens or the metal thin plate 20a. FIG. 1B is a top view of the irradiance measuring instrument 10 when viewed from the side of the objective 7.

The lens unit 20 is an optical system including a single lens that has a nearly flat surface oriented toward the side of the objective 7 and also has positive power. The lens unit 20 plays a role for making the light emitted from the objective 7 having a high numerical aperture incident to the sensor unit 30 at a small incidence angle. Note that the lens unit 20 may be configured with only the above described single lens. Alternatively, the lens unit 20 may be configured with a plurality of single lenses having positive power as long as the irradiance measuring instrument 10 is configured to have a thickness that can be arranged on the stage 8 of the microscope 1.

If the surface, on the side of the objective 7, of the single lens has a strongly convex shape, it is difficult to retain an immersion liquid. Alternatively, if the surface, on the side of the objective 7, of the single lens has a strongly concave shape, air bubbles are more prone to accumulate in the concave surface. Accordingly, it is preferable that the surface of the single lens on the side of the objective 7 is a nearly flat surface. Therefore, the nearly flat surface of the single lens is a surface having a degree of flatness that enables an immersion liquid to be satisfactorily retained between the objective 7 and the nearly flat surface itself. Since the nearly flat surface of the single lens functions as a surface that makes contact with the immersion liquid, it is preferable to arrange the single lens closest to the objective 7 within the lens unit 20.

Preferably, the single lens having the nearly flat surface oriented toward the side of the objective 7 is a lens having the spherical segment shape. The spherical segment shape is formed by cutting away a portion of a ball lens in such a way that the portion has a flat surface. Since a ball lens can be mass-produced, a manufacturing cost can be reduced. The single lens is processed from a ball lens. For this reason, a manufacturing cost of the lens unit 20 can be reduced. It is also preferable that the single lens has highly positive power in order to make the light emitted from the objective 7 that is used in a fluorescent observation or the like and has a high NA incident to the sensor unit 30 at a small incidence angle. Accordingly, it is preferable that a thickness on the optical axis of the single lens is larger than a curvature radius of the lens surface of the single lens. Here, the ball lens means a spherical lens. Accordingly, the lens in the spherical segment shape formed by cutting away a portion of the ball lens in such a way that the portion has a flat surface does not have an edge thickness in contrast to a normal convex lens.

The sensor unit 30 is a photodetector configured to detect light incident via the lens unit 20 and for converting the light into an electric signal. The electric signal output from the sensor unit 30 is used to measure irradiance of light on the nearly flat surface of the single lens. In other words, the sensor unit 30 detects light so as to measure the irradiance of light on the nearly flat surface of the single lens, namely, the sample surface.

The power meter main body 40 configures the power meter 50 along with the sensor unit 30 that is included in the irradiance measuring instrument 10 and connected by the cable 51.

The computer 60 includes a control unit such as a CPU (Central Processing Unit) or the like not illustrated, and memory units such as a ROM (Read Only Memory), a RAM (Random Access Memory) and the like in addition to a storage unit 62 configured with a hard disk device or the like. In the storage unit 62, transmittance data of the lens unit 20 for each wavelength is stored. Moreover, a magnification of projection from the field stop 4 onto the sample surface may be stored in the storage unit 62.

In the device 100 configured as described above, the light emitted from the light source 2 is covered into nearly collimated light by the collector lens 3, and incident to the field stop 4. The field stop 4 is arranged at a position optically conjugate with the sample surface. Accordingly, by adjusting a diameter of the field stop 4, an area of an irradiation field, a portion of the sample surface on which the light is irradiated, can be changed. The light that has passed through the field stop 4 is converted into convergent light that is collected at a pupil position of the objective 7 by the illumination lens 5, and incident to the fluorescence filter block 6. The light incident to the fluorescence filter block 6 is initially incident to the excitation filter 6b, and only the light having a wavelength suitable for excitation selectively passes through the excitation filter 6b. The light that has passed through the excitation filter 6b is reflected by the dichroic mirror 6a, and incident to the irradiance measuring instrument 10 from the nearly flat surface of the single lens included in the lens unit 20 via the objective 7.

The light emitted from the objective having a high NA is incident to the nearly flat surface of the single lens at a large incidence angle. However, the light is refracted by the lens unit 20 having positive power, so that the light is incident to a light-receiving surface of the sensor unit 30 at a small incidence angle. The sensor unit 30 to which the light has been incident transmits the electric signal obtained by photoelectrically converting the light to the power meter main body 40 connected by the cable 51. The power meter main body 40 converts an analog signal, which is the electric signal from the irradiance measuring instrument 10, into a digital signal that indicates a radiant flux (W) of light received by the sensor unit 30, and outputs the digital signal to the computer 60 connected by a cable 61.

The computer 60 receives the digital signal from the power meter 50, and measures the irradiance of the light emitted from the objective 7 of the microscope 1. Specifically, the computer 60 initially obtains transmittance data corresponding to a central wavelength of a transmittance distribution of the excitation filter 6b from the storage unit 62, and a magnification of projection from the field stop 4 onto the sample surface. Then, the computer 60 calculates the radiant flux of the light on the nearly flat surface (sample surface) of the signal lens included in the lens unit 20 by using the obtained transmittance data based on the following expression.

RF=(POUT/T)×100

where RF, POUT, and T respectively indicate the radiant flux (W) of the light on the sample surface, the radiant flux (W) of the light on the light-receiving surface of the sensor unit 30, which is indicated by the digital signal from the power meter 50, and the transmittance (%) of the lens unit 20.

Then, the computer 60 calculates the irradiance (W/m²) on the sample surface by dividing the radiant flux RF obtained based on the above provided expression by an area (the portion of the sample surface, on which light is irradiated) of the irradiation field. The area of the irradiation field is calculated, for example, based on the magnification of projection from the field stop 4 onto the sample surface, and a view field diameter of the field stop 4. A user may manually input the view field diameter of the field stop 4 with the input device 80 while referencing a GUI screen displayed on the monitor 70, or the computer 60 may automatically obtain the view field diameter based on settings of the microscope 1. Information such as the calculated radiant flux, irradiance, and the like are displayed on the monitor 70, and provided to the user of the device 100.

As described above, with the irradiance measuring instrument 10 and the device 100, light is incident to the sensor unit 30 at a small incidence angle with an action of the lens unit 20, whereby a detection error caused by a decrease in the detection efficiency of the sensor unit 30 can be reduced. Accordingly, irradiance can be measured with high accuracy.

Additionally, the lens unit 20 is arranged between the sample surface and the sensor unit 30, whereby the sensor unit 30 does not make contact with the immersion liquid. As a result, also a measurement using an immersion liquid can be supported. Therefore, irradiance can be measured under an actually used observation condition.

Furthermore, the incidence angle to the sensor unit 30 can be reduced, and also a measurement using an immersion liquid can be supported. Therefore, with the irradiance measuring instrument 10 and the device 100, irradiance can be measured with high accuracy even in a measurement using an objective having a high NA.

Still further, the sensor unit 30 of the irradiance measuring instrument 10 is separated from the power meter main body 40, so that the irradiance measuring instrument 10 can be downsized to reduce the thickness. Accordingly, the irradiance measuring instrument 10 can be arranged in a limited space on the stage 8.

Still further, with the irradiance measuring instrument 10 and the device 100, data of an objective is not needed to measure irradiance. Accordingly, irradiance can be measured with an arbitrary objective.

If the microscope 1 includes the irradiance measuring instrument 10, also the microscope 1 produces effects similar to those of the irradiance measuring instrument 10.

To measure the irradiance with higher accuracy, it is preferable to accurately grasp the area of the irradiation field. Accordingly, a dedicated aperture provided with a circular opening the area of which is accurately grasped in advance may be arranged at a position, which is conjugate with the sample surface and at which the field stop 4 is arranged, as a replacement for the normal field stop 4. As a result, the area of the irradiation field can be grasped with higher accuracy. Alternatively, the area of the irradiation field may be decided by means different from the field stop 4. For example, a pinhole maybe formed on the nearly flat surface of the single lens that is included in the lens unit 20 and closest to the objective, and the area of the irradiation field (more specifically, the portion of the sample surface, on which light detected by the sensor unit 30 is irradiated) may be decided based on an area of the pinhole. Specifically, light-shielding coating may be performed for the nearly flat surface except for a central portion, which may be made to function as the pinhole. By accurately grasping the area of the central portion that functions as the pinhole, irradiance can be measured with high accuracy.

Additionally, it is preferable that the irradiance measuring instrument 10 satisfies the following expressions (1) and (2).

D/(2×f)>1.3 (1)

IM/(20×f)<0.36 (2)

where D, f, and IM respectively indicate a length of a short side of the light-receiving surface of the sensor unit 30, a focal length of the lens unit 20, and a size of the primary image of the microscope 1.

The conditional expression (1) represents a relationship between the length of the short side of the light-receiving surface of the sensor unit 30 and the focal length of the lens unit 20. The left side of the conditional expression (1) represents a numerical aperture when the light is assumed to be vertically incident to the sensor unit 30. By satisfying the conditional expression (1), light emitted from an objective having a numerical aperture of 1.3 or larger can be made nearly vertically incident to the sensor unit 30. Therefore, irradiance can be accurately measured.

The conditional expression (2) represents a relationship between the focal length of the lens unit 20 and the size of the primary image of the microscope 1. The left side of the conditional expression (2) represents a sinusoidal value of an angle of a principal ray emitted from the lens unit 20. By satisfying the conditional expression (2), the principal ray can be made incident to the sensor unit 30 with an objective having a magnification of 10× or more, which is frequently used in a fluorescent observation, at an incidence angle of 30 degrees or smaller. For example, with an objective having a magnification of 20×, the principal ray can be made incident to the sensor unit 30 at an incidence angle of 17 degrees or smaller. Note that a distribution of the detection efficiency with the sensor unit 30 generally has a characteristic such that the detection efficiency significantly decreases at an incidence angle exceeding ±40 degrees although it is roughly flat at an incidence angle between ±20 degrees and ±30 degrees relative to 0 degrees as a center. Accordingly, by satisfying the conditional expression (2), irradiance can be measured with high accuracy with an objective having a magnification normally used in a fluorescent observation.

### First Embodiment

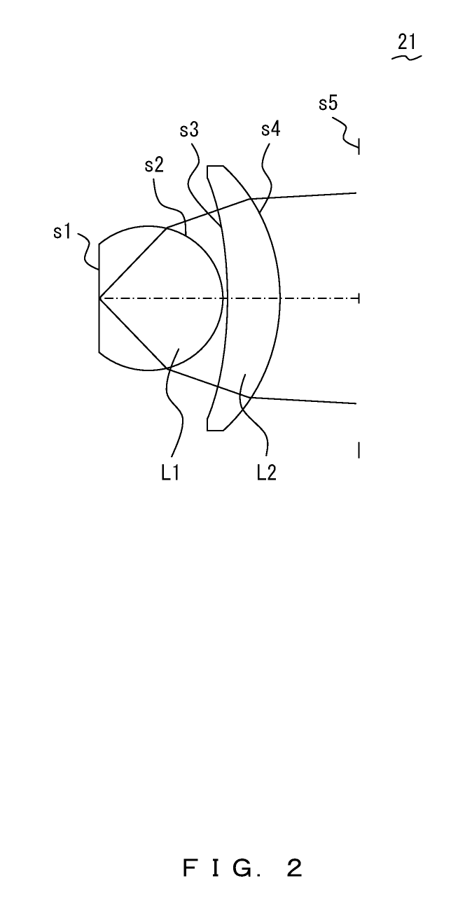

FIG. 2 is a cross-sectional view of an optical system included in an irradiance measuring instrument for a microscope according to this embodiment. The irradiance measuring instrument for a microscope according to this embodiment includes a lens unit 21 illustrated in FIG. 2 as the lens unit 20. Other points are similar to the irradiance measuring instrument 10 illustrated in FIGS. 1A and 1B. The objective 7 is arranged on the left side of FIG. 2 although it is not illustrated in this figure.

The lens unit 21 includes, as illustrated in FIG. 2, a lens L1, which is a single lens that has a flat surface oriented toward the side of the objective 7 and also has positive power, and a lens L2, which is a second single lens having positive power, in an order where the light emitted from the objective 7 proceeds. The lens L1 is a lens in the spherical segment shape formed by cutting part of a ball lens as a flat surface. A thickness on the optical axis of the lens L1 is larger than a radius of the ball lens. The lens L2 is a meniscus lens having a concave surface oriented toward the side of the objective 7. Between the flat surface of the lens L1 and the objective 7 not illustrated, oil is filled as an immersion liquid.

A focal length f and a numerical aperture NA of the lens unit 21 are as follows.

f=2.85 mm, NA=1.4

A refractive index N with respect to a d line and an Abbe number V of the oil filled between the lens L1 and the objective 7 are as follows.

N=1.51548, V=43.1

Lens data of the lens unit 21 are as follows.

the lens unit 21

| s | r | d | nd | vd |
|---|---|---|---|---|
| 1 | INF | 4.0000 | 1.77250 | 49.60 |
| 2 | −2.4610 | 0.1500 | | |
| 3 | −13.6110 | 1.7100 | 1.77250 | 49.60 |
| 4 | −5.9940 | 2.5000 | | |
| 5 | INF | | | |

where s, r, d, nd, and vd respectively indicate a surface number, a curvature radius (mm), a surface interval (mm), a refractive index with respect to the d line, and the Abbe number. Surface numbers s1 and s5 respectively indicate a surface of the lens L1 on the side of the objective 7 and the light-receiving surface of the sensor unit 30.

The lens unit 21 satisfies the expressions (1) and (2) as represented by the following expressions (A1) and (A2). Here, the length D of the short side of the light-receiving surface of the sensor unit 30, and the size IM of the primary image of the microscope 1 are assumed to be approximately 9.6 mm and 11 mm, respectively.

D/(2×f)=1.68 (A1)

IM/(20×f)=0.19 (A2)

Since the lens unit 21 is configured with the two lenses having positive power, excessively high power is not demanded for the lens L1. To obtain higher power only with the lens L1, it is needed to reduce an absolute value of the curvature radius of the surface indicated by the surface number s2, or to increase the refractive index of the lens L1. If the curvature radius is excessively reduced, total reflection can possibly occur on the surface indicated by the surface number s2 when the irradiance measuring instrument is arranged at a position where the optical axis of the lens unit 21 deviates from that of the objective. Moreover, if a material having a high refractive index is used for the lens L1, transmittance of an ultraviolet ray deteriorates. Accordingly, with the irradiance measuring instrument including the lens unit 21 that obtains needed positive power with the lens L1 and the lens L2, irradiance can be measured with high accuracy while securing transmittance of an ultraviolet ray frequently used in a fluorescent observation.

### Second Embodiment

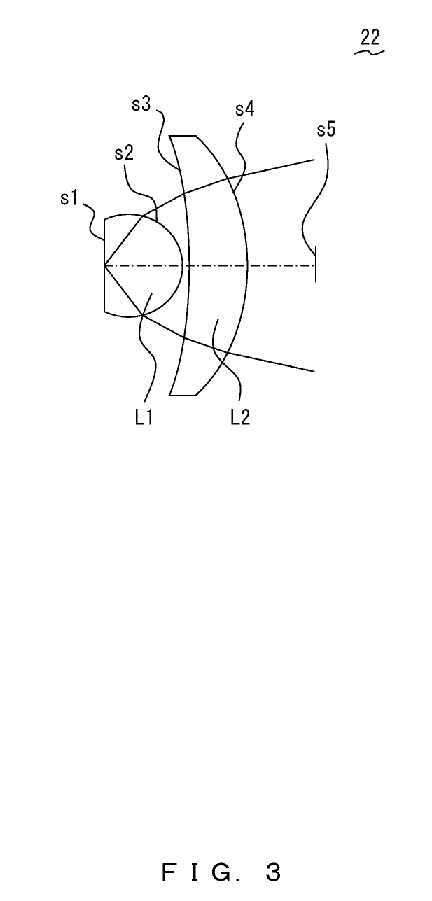

FIG. 3 is a cross-sectional view of an optical system included in an irradiance measuring instrument for a microscope according to this embodiment. The irradiance measuring instrument according to this embodiment includes a lens unit 22 illustrated in FIG. 3 as the lens unit 20. Other points are similar to the irradiance measuring instrument 10 illustrated in FIGS. 1A and 1B. The objective 7 is arranged on the left side of FIG. 3 although it is not illustrated in this figure.

The lens unit 22, as illustrated in FIG. 3, includes a lens L1, which is a single lens that has a flat surface oriented toward the side of the objective 7 and also has positive power, and the lens L2, which is a second single lens having positive power, in an order where the light emitted from the objective 7 proceeds. The lens L1 is a lens in the spherical segment shape formed by cutting away a portion of a ball lens in such a way that the portion has a flat surface. A thickness on the optical axis of the lens L1 is larger than a radius of the ball lens. The lens L2 is a meniscus lens having a concave surface oriented toward the side of the objective 7. Between the flat surface of the lens L1 and the objective 7 not illustrated, oil is filled as an immersion liquid.

A focal length f and a numerical aperture NA of the lens unit 22 are as follows.

f=1.81 mm, NA=1.49

A refractive index N with respect to a d line and an Abbe number V of the oil filled between the lens L1 and the objective 7 are similar to those of the first embodiment.

Lens data of the lens unit 22 are as follows.

the lens unit 22

| s | r | d | nd | vd |
|---|---|---|---|---|
| 1 | INF | 2.4000 | 1.88300 | 40.76 |
| 2 | −1.6000 | 0.2000 | | |
| 3 | −13.6110 | 1.7100 | 1.77250 | 49.60 |
| 4 | −5.9940 | 2.0400 | | |
| 5 | INF | | | |

where s, r, d, nd, and vd respectively indicate a surface number, a curvature radius (mm), a surface interval (mm), a refractive index with respect to the d line, and the Abbe number. Surface numbers s1 and s5 respectively indicate a surface of the lens L1 on the side of the objective 7 and the light-receiving surface of the sensor unit 30.

The lens unit 22 satisfies the expressions (1) and (2) as represented by the following expressions (B1) and (B2). Here, the length D of the short side of the light-receiving surface of the sensor unit 30, and the size IM of the primary image of the microscope 1 are assumed to be approximately 9.6 mm and 11 mm, respectively.

D/(2×f)=2.66 (B1)

IM/(20×f)=0.3 (B2)

Since the lens unit 22 is configured with the two lenses having positive power similarly to the lens unit 21 of the first embodiment, excessively high power is not demanded for the lens L1. Accordingly, with the irradiance measuring instrument including the lens unit 22 that obtains needed positive power with the lens L1 and the lens L2, irradiance can be measured with high accuracy while securing transmittance of an ultraviolet ray frequently used in a fluorescent observation.

### Third Embodiment

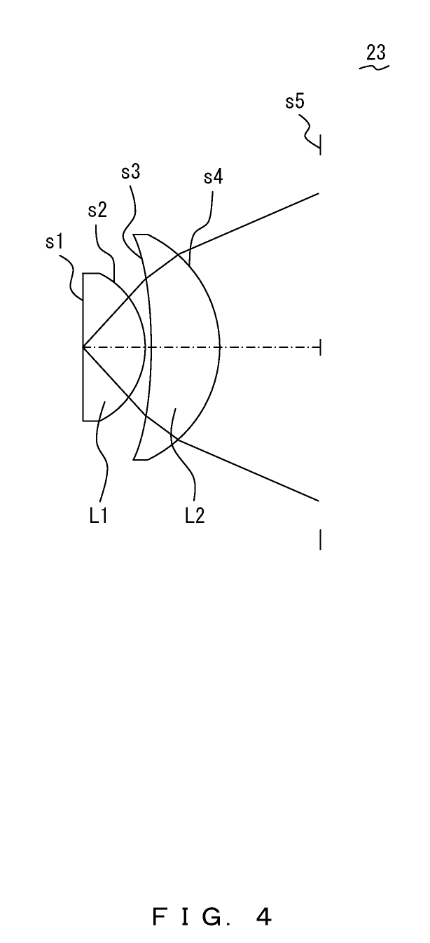

FIG. 4 is a cross-sectional view of an optical system included in an irradiance measuring instrument for a microscope according to this embodiment. The irradiance measuring instrument according to this embodiment includes a lens unit 23 illustrated in FIG. 4 as the lens unit 20. Other points are similar to the irradiance measuring instrument 10 illustrated in FIGS. 1A and 1B. The objective 7 is arranged on the left side of FIG. 4 although it is not illustrated in this figure.

The lens unit 23 includes, as illustrated in FIG. 4, a lens L1, which is a single lens that has a flat surface oriented toward the side of the objective 7 and also has positive power, and a lens L2, which is a second single lens having positive power, in an order where the light emitted from the objective 7 proceeds. The lens L1 is a plano convex lens having a flat surface oriented toward the side of the objective 7, whereas the lens L2 is a meniscus lens having a concave surface oriented toward the side of the objective 7. Between the flat surface of the lens L1 and the objective 7 not illustrated, oil is filled as an immersion liquid.

A focal length f and a numerical aperture NA of the lens unit 23 are as follows.

f=2.11 mm, NA=1.3

A refractive index N with respect to a d line and an Abbe number V of the oil filled between the lens L1 and the objective 7 are similar to those of the first embodiment.

Lens data of the lens unit 23 are as follows.

the lens unit 23

| s | r | d | nd | vd |
|---|---|---|---|---|
| 1 | INF | 1.5000 | 1.77250 | 49.60 |
| 2 | −2.0000 | 0.1500 | | |
| 3 | −10.0000 | 1.7100 | 1.77250 | 49.60 |
| 4 | −3.1000 | 2.5000 | | |
| 5 | INF | | | |

where s, r, d, nd, and vd respectively indicate a surface number, a curvature radius (mm), a surface interval (mm), a refractive index with respect to the d line, and the Abbe number. Surface numbers s1 and s5 respectively indicate a surface of the lens L1 on the side of the objective 7 and the light-receiving surface of the sensor unit 30.

The lens unit 23 satisfies the expressions (1) and (2) as represented by the following expressions (C1) and (C2). Here, the length D of the short side of the light-receiving surface of the sensor unit 30, and the size IM of the primary image of the microscope 1 are assumed to be approximately 9.6 mm and 11 mm, respectively.

D/(2×f)=2.27 (C1)

IM/(20×f)=0.26 (C2)

Since the lens unit 23 is configured with the two lenses having positive power similarly to the lens unit 21 of the first embodiment, excessively high power is not demanded for the lens L1. Accordingly, with the irradiance measuring instrument including the lens unit 23 that obtains needed positive power with the lens L1 and the lens L2, irradiance can be measured with high accuracy while securing transmittance of an ultraviolet ray frequently used in a fluorescent observation.

### Fourth Embodiment

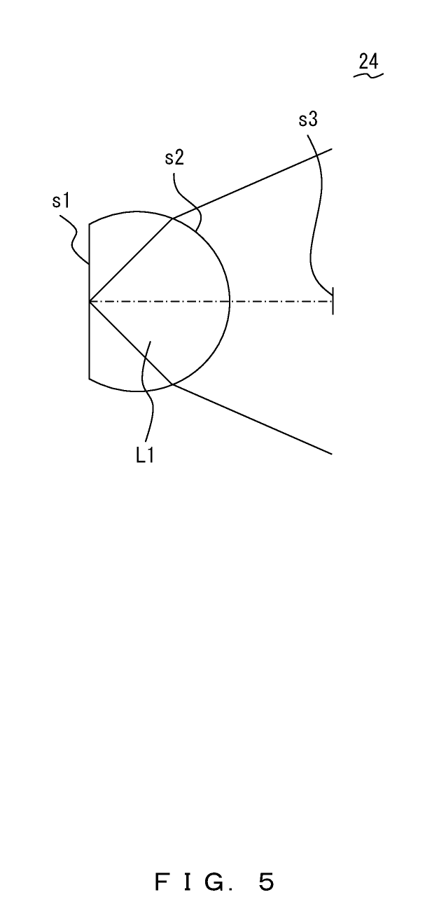

FIG. 5 is a cross-sectional view of an optical system included in an irradiance measuring instrument for a microscope according to this embodiment. The irradiance measuring instrument according to this embodiment includes a lens unit 24 illustrated in FIG. 5 as the lens unit 20. Other points are similar to the irradiance measuring instrument 10 illustrated in FIGS. 1A and 1B. The objective 7 is arranged on the left side of FIG. 5 although it is not illustrated in this figure.

The lens unit 24 is configured, as illustrated in FIG. 5, with a lens L1, which is a single lens that has a flat surface oriented toward the side of the objective 7 and also has positive power. The lens L1 is a lens in the spherical segment shape formed by cutting away a portion of a ball lens in such a way that the portion has a flat surface. A thickness on the optical axis of the lens L1 is larger than a radius of the ball lens. Between the flat surface of the lens L1 and the objective 7 not illustrated, oil is filled as an immersion liquid.

A focal length f and a numerical aperture NA of the lens unit 24 are as follows.

f=2.04 mm, NA=1.35

A refractive index N with respect to a d line and an Abbe number V of the oil filled between the lens L1 and the objective 7 are similar to those of the first embodiment.

Lens data of the lens unit 24 are as follows.

the lens unit 24

| s | r | d | nd | vd |
|---|---|---|---|---|
| 1 | INF | 2.7000 | 1.88300 | 40.76 |
| 2 | −1.8000 | 2.0000 | | |
| 3 | INF | | | |

where s, r, d, nd, and vd respectively indicate a surface number, a curvature radius (mm), a surface interval (mm), a refractive index with respect to the d line, and the Abbe number. Surface numbers s1 and s3 respectively indicate a surface of the lens L1 on the side of the objective 7 and the light-receiving surface of the sensor unit 30.

The lens unit 24 satisfies the expressions (1) and (2) as represented by the following expressions (D1) and (D2). Here, the length D of the short side of the light-receiving surface of the sensor unit 30, and the size IM of the primary image of the microscope 1 are assumed to be approximately 9.6 mm and 11 mm, respectively.

D/(2×f)=2.35 (D1)

IM/(20×f)=0.27 (D2)

Since the lens unit 24 is configured with only one single lens unlike the lens units in the other embodiments, the thickness of the lens unit 24 can be reduced. Accordingly, with the irradiance measuring instrument including the lens unit 24 configured with the lens L1, irradiance can be measured with high accuracy, and at the same time, the irradiance measuring instrument can be further downsized in comparison with the other irradiance measuring instruments according to the other embodiments.

The first to the fourth embodiments refer to the examples where the irradiance measuring instrument includes the particular lens unit. However, the lens unit of the irradiance measuring instrument may be replaceable. For example, an arbitrary one of the lens units (the lens unit 21, the lens unit 22, the lens unit 23, and the lens unit 24) according to the first to the fourth embodiments may be selected and mounted. Any of the lens units can be used to suit the needs, for example, in a way such that a lens unit having a small thickness is used when irradiance is measured with an objective having a small NA or a lens unit having a large thickness is used when irradiance is measured with an objective having a large NA. By using a lens unit having a small thickness, a space between a condenser, not illustrated in FIG. 1A, for epi-illumination and the stage can be secured. This is advantageous in performing various operations. Moreover, a lens unit that makes a UV ray pass through, and a lens unit having transmittance up to a wavelength range of IR light may be provided and switched according to a wavelength of light to be measured.

The above described embodiments refer to the specific examples in order to facilitate understanding of the invention, and the present invention is not limited to the above described embodiments. The irradiance measuring instrument and the microscope according to the embodiments can be variously modified and changed within a scope that does not depart from the spirit of the present invention stipulated by claims.

What is claimed is:

1. An irradiance measuring instrument for a microscope, which is intended to measure irradiance of light emitted from an objective of the microscope, comprising, in an order where the light emitted from the objective proceeds:
an optical system including a single lens that has a nearly flat surface oriented toward a side of the objective and also has positive power; and
a photodetector configured to detect the light in order to measure the irradiance of the light on the nearly flat surface.

2. The irradiance measuring instrument for a microscope according to claim 1, wherein
the single lens is arranged closest to the side of the objective.

3. The irradiance measuring instrument for a microscope according to claim 1, wherein
the single lens is a lens in the spherical segment shape formed by cutting away a portion of a ball lens in such a way that the portion has a flat surface.

4. The irradiance measuring instrument for a microscope according to claim 3, wherein
A thickness on an optical axis of the single lens is larger than a radius of the ball lens.

5. The irradiance measuring instrument for a microscope according to claim 1, wherein
the optical system comprises, in an order where the light emitted from the objective proceeds,
the single lens that has the nearly flat surface oriented toward the side of the objective and also has positive power, and
a second single lens having positive power.

6. The irradiance measuring instrument for a microscope according to claim 4, wherein
when a focal length of the optical system, and a length of a short side of a light-receiving surface of the photodetector are respectively assumed to be f and D, a conditional expression
D/(2×f)>1.3
is satisfied.

7. The irradiance measuring instrument for a microscope according to claim 1, wherein
when a focal length of the optical system, and a size of a primary image of the microscope are respectively assumed to be f and IM, a conditional expression
IM/(20×f)<0.36
is satisfied.

8. The irradiance measuring instrument for a microscope according to claim 1, further comprising
an indicator part for arranging the irradiance measuring instrument for a microscope at a specified position with respect to an optical axis of the objective on the side of the nearly flat surface of the single lens.

9. The irradiance measuring instrument for a microscope according to claim 1, wherein
the irradiance measuring instrument is configured to have a thickness that can be arranged on a stage of an inverted microscope.

10. A microscope comprising the irradiance measuring instrument for a microscope according to claim 1.
